(19) United States
(12) Patent Application Publication
(10) Pub. No.: US 2016/0177643 A1
(43) Pub. Date: Jun. 23, 2016

(54) MODULAR FIBER FEEDER

(71) Applicant: SCHLUMBERGER TECHNOLOGY CORPORATION, Sugar Land, TX (US)

(72) Inventor: Hau Nguyen-Phuc Pham, Houston, TX (US)

(21) Appl. No.: 14/573,986

(22) Filed: Dec. 17, 2014

(51) Int. Cl. E21B 21/06; B28C 5/08; G01F 11/24

(52) U.S. Cl. CPC E21B 21/062; G01F 11/24; B28C 5/08

(57) ABSTRACT

An apparatus is disclosed, which controls and meters the feed of fibers into a fluid which includes a housing having an intake opening and a discharge opening, two or more toothed metering elements mounted on a plurality of spindles, and a shear bar disposed within the housing above and between the toothed metering elements. The spindles are rotatably mounted within the housing. A fluid is disposed adjacent the discharge opening for receiving fibers. In some cases, a mass of fibers is introduced into the apparatus via the intake opening, the mass of fibers contacts the shear bar and the toothed metering elements, and may be divided into substantially discrete fibers by the contact with the shear bar and the toothed metering elements, and delivery of the fibers to the fluid is metered by controlling rotational speed of the toothed metering elements.

### FIELD

The field to which the disclosure generally relates to includes apparatus and methods for supplying and metering fiber introduction into fluids, and in particular, supplying and metering fiber into fluids useful in oilfield applications.

### BACKGROUND

The statements in this section merely provide background information related to the present disclosure and may not constitute prior art.

The production of hydrocarbons from an oilfield occurs primarily through a wellbore penetrating a subterranean formation. The wellbore may include access to fractures extending radially into surrounding geologic formations. Such fractures may be beneficial to hydrocarbon production, and may be created by a fracturing operation performed in advance of hydrocarbon production in order to intentionally form fractures extending from the wellbore into a subterranean formation. That is, the well may display an architectural profile having a variety of particularly located fracture sites built thereinto in an effort to maximize hydrocarbon production from the well.

In a fracturing operation, a fracturing fluid may be pumped at high pressure into the wellbore to form the fractures and stimulate production of the hydrocarbons. The fractures may serve as channels through the formation through which hydrocarbons may reach the wellbore. Fracturing fluid may also include a solid particulate referred to as proppant, which may be placed in or primarily within the fracture(s) during or after their formation, and maintain the fracture(s) propped open.

In certain circumstances, the proppant or other particulate contaminants from the surrounding formation may fail to remain in place. For example, fracturing or other fluid may flow back into the wellbore from the fractures bringing the proppant and other particulates along in a circumstance referred to as “flowback”. When this occurs, hydrocarbon production is impeded as opposed to being enhanced. This is a common occurrence in the case of unconsolidated formations as well as those that have undergone gravel packing and other treatments that add particulate to the well.

To help avoid the flowback of fracturing fluid and proppant, or other solid particulate into the wellbore, methods have been developed in which fibers are added to the fracturing fluid in order to provide the fluid with a flowback inhibiting character. The incorporation of such fibers into the fracturing fluid may substantially prevent the flowback of proppant into the wellbore. The fibers may provide the fracturing fluid with characteristics that inhibit the flowback of fracturing fluid and proppant along with any other solid particulate. That is, the fracturing fluid may display a web-like character that acts to trap particulate at a fracture and other sites of the well, thus substantially preventing their flowback. Flowback inhibiting fibers are added to the fracturing fluid at the well site during, or immediately prior to, the delivery of the treatment fluid to the well. In this manner, the web-like character of the fracturing fluid is fully achieved upon its arrival downhole (e.g. within a fracture) rather than at a random location within the borehole.

When adding fibers to the fluid at the wellsite, the fibers have traditionally been difficult to handle and meter at target concentrations in fracturing operations. The same is the case for cementing operations as well which can include the incorporation of fibers into cementing fluids. Problems that typically arise with the existing fiber metering and delivery systems involve the fibers jamming the metering equipment and plugging conveyance chutes. Thus, there is a need for improved fiber metering and delivery systems which avoid the above described problems, and such need is addressed, at least in part, by embodiments described in the following disclosure.

### SUMMARY

This section provides a general summary of the disclosure, and is not necessarily a comprehensive disclosure of its full scope or all of its features.

In a first aspect of the disclosure, an apparatus, which controls and meters the feed of fibers into a fluid, is provided. The apparatus includes a housing having an intake opening and a discharge opening, two or more toothed metering elements mounted on a plurality of spindles, and a shear bar disposed within the housing above and between the toothed metering elements. The spindles are rotatably mounted within the housing. A fluid is disposed adjacent the discharge opening for receiving fibers. In some cases, a mass of fibers is introduced into the apparatus via the intake opening, the mass of fibers contacts the shear bar and the toothed metering elements, and delivery of the fibers to the fluid is metered by controlling rotational speed of the toothed metering elements. The plurality of spindles with toothed metering elements may be two spindles, and the spindles may rotate in opposite directions. The mass of fibers may be divided into substantially discrete fibers by the contact with the shear bar and the toothed metering elements, and the discrete fibers delivered to the liquid by passing through the apparatus.

In some aspects, the spindles are drums, each having one or more slots disposed on the surface of such drum, the slots orientated parallel with an axial centerline of the drum, and the slots may accommodate inserts including the toothed metering elements. Each of the drums may further include distally positioned axles disposed upon the axial centerline of the drum and extending from each end of the drum, a retainer cap disposed over each axle and mated with the drum to secure the inserts, and a lock for securing the retainer cap over the axle. In some aspects, the ends of each drum may serve as an axle. The axles may extend through walls of the housing, and be rotatable secured within.

The shear bar may function as a shearing surface for the toothed metering elements to work against. The shear bar may further help prevent fiber loaded into the apparatus just above the drums from jamming between the spindles. Further, teeth on the toothed metering elements may tear into the fiber and shear the fiber against the shear bar to separate the fiber, and meter fiber discharge through the discharge opening.

The fluid may be any fluid requiring fiber added thereto, and may include oilfield fluids such as fracturing fluid, cementing fluid, drilling fluid, gravel packing fluid, and the like.

In another aspect of the disclosure, a system is provided which includes a fiber feed control apparatus having a housing having an intake opening and a discharge opening, a mass of fibers received at the intake opening, a plurality of toothed metering elements mounted on a plurality of spindles (the spindles rotatably mounted within the housing) a shear bar disposed above and between the plurality of toothed metering elements, and fibers to be discharged at the discharge opening. The system further includes a fluid disposed adjacent the discharge opening for receiving and mixing with the fibers discharged by the fiber feed control apparatus. In some aspects, the spindles are drums, each having one or more slots disposed on the surface of such drum, the slots orientated parallel with an axial centerline of the drum, and the slots may accommodate inserts including the toothed metering elements. Each of the drums may further include distally positioned axles disposed upon the axial centerline of the drum and extending from each end of the drum through walls of the housing, and be rotatably secured within the housing, and may further include a retainer cap disposed over each axle and mated with the drum to secure the inserts, and a lock for securing the retainer cap over the axle. The drums may be two drums which rotate in opposing directions. The fluid may be any fluid requiring fiber added thereto, and may include oilfield fluids such as fracturing fluid, cementing fluid, drilling fluid, gravel packing fluid, and the like.

Yet another aspect includes a system for preparing a subterranean formation treatment fluid, the system including an apparatus having a housing with an intake opening and a discharge opening, a mass of fibers received at the intake opening, a plurality of toothed metering elements mounted on a plurality of drums, a shear bar disposed above and between the plurality of toothed metering elements, a treatment fluid disposed adjacent the discharge opening, and fibers to be discharged from the discharge opening. The fibers are continuously discharged at a substantially constant rate and added to the treatment fluid.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 illustrates an oilfield where a fracturing operation is performed using apparatus and systems provided in accordance with an aspect of the disclosure;

FIG. 2 depicts a fiber feed control apparatus, in accordance with some aspects of the disclosure, in a perspective view;

FIGS. 3a and 3b illustrate spindles which are rotatable drums securing a plurality of toothed metering elements, according to an aspect of the disclosure, in perspective views;

FIG. 4 depicts a pattern of a plurality of toothed metering elements, according to an aspect of the disclosure, in a perspective view;

FIG. 5 illustrates a vertical hopper disposed adjacent a fiber feed control apparatus, according to an aspect of the disclosure, in a transparent perspective view;

FIG. 6 depicts operation of a vertical hopper and a fiber feed control apparatus, according to an aspect of the disclosure, in a cross-sectional view; and,

FIG. 7 illustrates an oilfield scheme where a cementing operation is performed using apparatus and systems provided accordance with an aspect of the disclosure.

### DETAILED DESCRIPTION

The following description of the variations is merely illustrative in nature and is in no way intended to limit the scope of the invention, its application, or uses. The description and examples are presented herein solely for the purpose of illustrating the various embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration, amount or measurement range listed or described as being useful, suitable, or the like, is intended that any and every concentration or amount or measurement within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Some aspects of the disclosure relate to apparatus useful for separating a mass of fibers and introducing the separated fibers to fluids. The fibers may be delivered to the fluid by gravity, pressure, mechanical manipulation, or any other suitable device or method for moving fibers into fluid after separation. The mass of fibers may be introduced into the apparatus by gravity, pressure, mechanical manipulation, or any other suitable device or method, as well. The fluid containing the discrete fibers may, in some cases, be useful for subterranean formation fracturing and/or wellbore cementing applications. However, other types of oilfield applications and fluids may realize benefits afforded by embodiments described herein. For example, drilling applications may employ techniques described herein. Regardless, some embodiments described herein employ an apparatus to deliver fiber, from a readily transportable fibrous mass supply thereof, to an oilfield application fluid on-site.

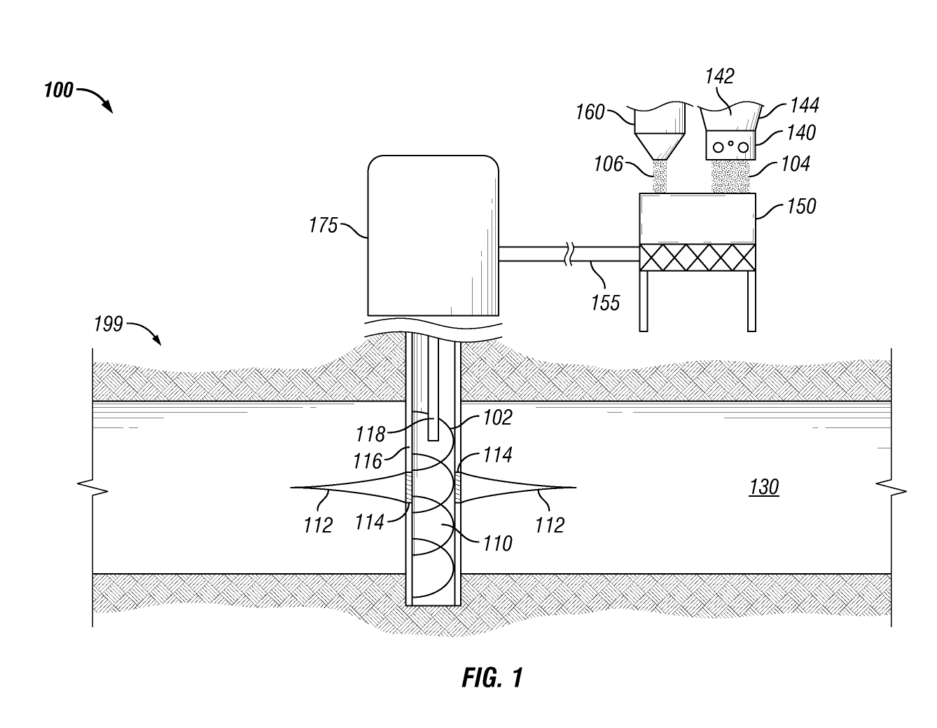

Referring now to FIG. 1, an oilfield 100 is depicted where a fracturing operation is performed. The fracturing operation may be employed to facilitate the production of hydrocarbons from a well 110 through an underground formation 199. In the embodiment shown, a fracturing fluid mixture 102 is delivered to the well 110 under high pressure in order to promote the formation of fractures 112. Fractures 112 may traverse a production region 130 of the formation 199 in order to target the location of hydrocarbons. As shown, the fracturing fluid mixture 102 is able to penetrate the production region 130 through perforations 114 in the well casing 116, as the well 110 may be configured with a casing 116 having perforations 114 at predetermined locations that are aligned with the position of the production region 130. Thus, the highly pressurized fracturing fluid mixture 102 may be forced down the well 110 from a discharge pipe 118 at a high enough pressure to permeate outside of the well 110, through the perforations 114 and into the formation 199 to form the fractures 112. Targeted hydrocarbons, generally oil and natural gas, may thereby be recovered from the production region 130 through the fractures 112.

The fracturing fluid mixture 102 may be provided to the well 110 after preparation in a mixing system 150. Once the mixture 102 is attained it may be directed through the well 110 by a series of high pressure pumps. For example a series of conventional large scale triplex pumps (not shown) may be employed together, linked through a common manifold and coupled to the well head 175. The combined output of these pumps may be mechanically collected and distributed according to the parameters of the fracturing operation. The fracturing fluid mixture 102 may thus be driven into the well formation 199 for fracturing rock and forming fractures 112 as described above. In one embodiment, a series of between about 4 and about 20 triplex pumps are provided at the oilfield 100 for such a fracturing operation.

The fracturing fluid mixture 102 is provided to the high pressure pumps for fracturing from a mixing system 150. That is, a mix system 150 may be provided whereat constituents 104 and 106 are combined to form the fracturing fluid mixture 102 just prior to its high pressure downhole injection as described above. An exit pipe 155 may be employed to carry the mixture 102 from the mix system 150 to the above noted pumps or other post-mix processing locations at the oilfield 100. Regardless, constituents 104 and 106 are combined at the oilfield 100 to form the fracturing fluid mixture 102 at the time of the fracturing operation. As described below, this allows the fracturing fluid mixture 102 to be advanced throughout the fracturing equipment at the oilfield 100 and through the well 110 prior to taking on any sticky gel-like properties or a web-like character that might otherwise impede such advancement.

Continuing with reference to FIG. 1, the mix system 150 is shown receiving constituents 104 and 106 from multiple sources. One such source may include an apparatus, such as the depicted fiber feed control apparatus 140 for delivering fiber 104 to the mix system 150. Additionally, fluid 106, such as a fracturing fluid 106, may be provided to the mix system 150 through a feeder 160. The fracturing fluid 106 itself may be an abrasive slurry made up of water (viscosified or slickwater), or other liquid with a proppant such as sand, ceramic material, bauxite, and/or a variety of other abrasive additives blended therein. These components of the fracturing fluid 106 may be blended together prior to delivery at the mix system 150 as shown in FIG. 1. However, in other embodiments components may be individually provided to the mix system 150 for mixing thereat.

Regardless of whether the components of the fracturing fluid 106 are pre-mixed or individually fed to the mix system 150, the fiber 104 is individually provided to the mix system 150, and in some instances, upon addition of the fracturing fluid 106 or its components thereto. The fiber 104 may provide a web-like character to the fracturing fluid mixture 102 once dispersed therethrough. A process of congealing may ensure that, within a matter of under a few hours, a web-like character is imparted into the fracturing fluid mixture 102 that substantially prohibits its free flow of movement through the described oilfield delivery equipment. As also described below, this may be of benefit in avoiding flowback of the fracturing fluid mixture 102 into the well 110 from the production region 130. However, this characteristic of the fiber 104 provides good reason to have the fiber 104 separately added to the fracturing fluid 106 as opposed to providing a pre-mixed, most likely unworkable, fracturing fluid mixture 102 with fiber 104 already blended therein.

Given that the fiber 104 is to be separately or individually added to the mix system 150 as indicated, a fiber feed control apparatus 140 may be provided to receive a fiber mass 142 and discharge the fiber 104 to the mix system 150. Although specific embodiments of the fiber feed control apparatus 140 are described below, the fiber feed control apparatus 140 may be any apparatus appropriate for metering, separating and optionally cutting, fiber mass 142 as fibers 104 are delivered to the mixing system 150.

In some embodiments of the disclosure, the fiber feed control apparatus 140 is a housing having an intake opening and a discharge opening with several toothed metering elements mounted on a pair of spindles, such as a rod, pin, cylinder, or shaft, serving as an axis that revolves the mounted toothed metering elements. The spindles are rotatably mounted to and within the housing. A shear bar is disposed above and between the plurality of toothed metering elements. The shear bar provides shearing surface for the toothed metering elements to work against, and also may help prevent fiber mass introduced into the housing above the spindles from jamming in between the spindles, as the spindles are rotated and fibers move there between. In operation, the spindles rotate towards each other such that teeth on the toothed metering elements act as paddles that move fiber down from the inside of the housing and out of the discharge opening below the spindles. For packed fiber masses, the teeth may tear into the fiber and shear the fiber against the shear bar to separate the fiber into more discrete particles, and meter through the discharge opening.

In some other aspects, a vertical-sided hopper, such as 144 in FIG. 1, may be disposed adjacent an intake opening of the fiber feed control apparatus 140, and the hopper may contain and facilitate delivery of fiber mass 142. The dimensions of the vertical-sided hopper with respect to the position of the shear bar at the interface where fiber falls onto the spindles may be proportioned to provide controlled fiber bridging directly above each spindle on either side of the shear bar to help promote uniform packing of fiber for consistent metering results, particularly when the hopper is fully loaded with a given weight of fiber that is restricted by the size of the hopper.

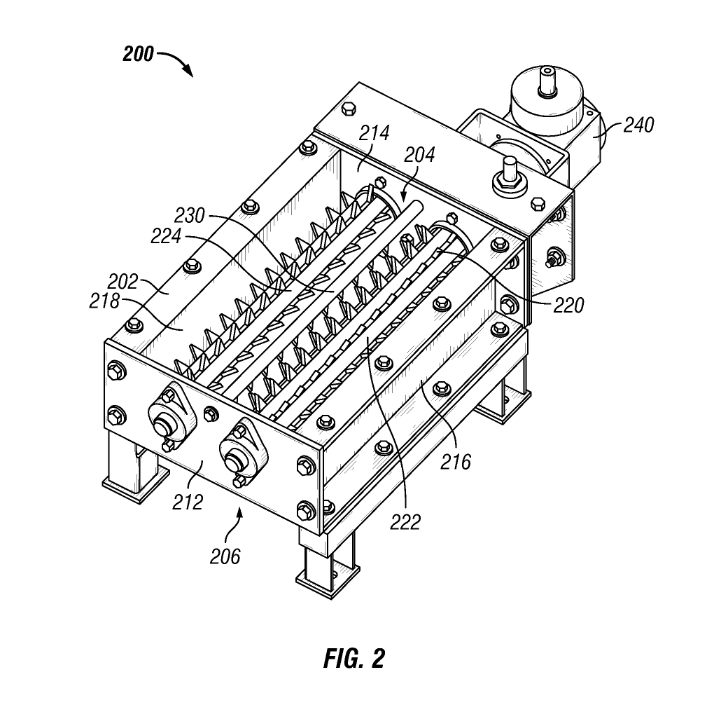

Referring now to FIG. 2, which depicts a fiber feed control apparatus 200, in accordance with some aspects of the disclosure, in a perspective view. Apparatus 200 generally includes a housing 202 having an intake opening 204 and a discharge opening 206 on the opposing side. Housing 202 includes sides 212, 214, 216 and 218, which form an essentially rectangular structure defining a space therein. While a rectangular structure is depicted, any suitable shape of the structure is within the spirit and scope of the disclosure. Disposed within the housing are a plurality of toothed metering elements (eight shown) 220 which are mounted on a plurality of spindles (two shown) 222, 224. The spindles 222, 224 are rotatably mounted to opposing sides 212, 214 of housing 202. A shear bar 230 is disposed above and between the plurality of toothed metering elements 220, and mounted to, and can extend through, opposing sides 212, 214 of housing 202. A gearbox 240, driven by an engine, motor, or any suitable means, may be mounted to housing 202 in order to rotate spindles 222, 224. In operation, a mass of fibers may be received at the intake opening 204, the mass of fibers then contacts shear bar 230 and toothed metering elements 220, the throughput metered by controlling rotational speed of the spindles and the plurality of toothed metering elements, and then discharged from discharge opening 206 to be added to, or otherwise mixed with, a fluid disposed adjacent the discharge opening, as described in further detail below.

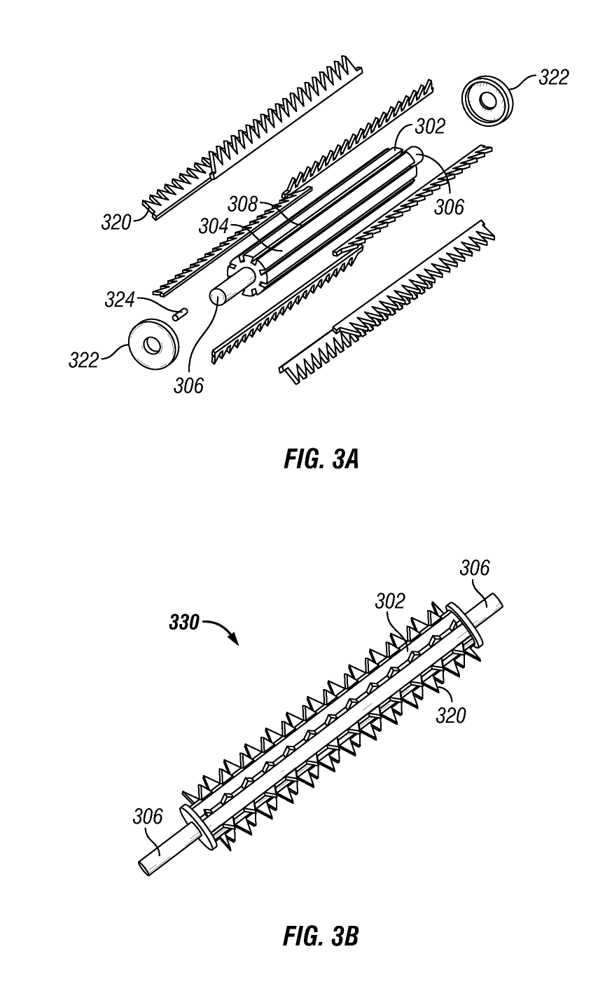

FIG. 2 depicts toothed metering elements 220 mounted on a plurality of spindles 222, 224. As shown in FIGS. 3a and 3b, in some aspects, the spindles may be rotatable drums securing a plurality of toothed metering elements, and arranged in a way to provide a high degree of modularity for ease of assembly and maintenance. Drum 302 includes a cylindrical section 304 and axles 306 disposed on opposing sides of cylindrical section 304, and upon the axial centerline of drum 302. In some aspects, the ends of each drum 302 may serve as an axle 306 (not shown). Drum 302 includes multiple lengthwise slots (seven shown) 308 disposed around the circumference of each drum to accommodate toothed metering elements (eight shown) 320. Toothed metering elements 320 may be of a tooth shaped configuration, paddled shaped configuration, combs, needles, combinations thereof, or any suitable design. In some instances, the teeth and/or paddles may be varied in spacing, number, shape, and the like, while in other cases, consistent in spacing, number, and/or shape. An advantage of the modular design is toothed metering elements 320 may be installed or removed from the slots 308 of drums 302 as needed, depending upon factors such as required metering rates, fiber type, fiber condition (wet, dry, etc.), and the like. The arrangement depicted in FIG. 3a may further include such components as retainer caps 322 disposed over each distal axle 306 which are mated with cylindrical section 304 to secure toothed metering elements 320 in slots 308. A locking mechanism 324, which may be a lock ring, pin, screw, and the like, may be used for securing the retainer caps 322 on axles 306.

FIG. 3b depicts, in a perspective view, the assembled configuration of components depicted in FIG. 3a, forming fiber metering implement 330. Fiber metering implement 330, includes drum 302 with axles 306 and toothed metering elements 320 securely mounted on drum 302. Axles 306 may be rotatably mounted within a housing, such as housing 202 shown in FIG. 2. One axle 306, or both, may extend through a wall of the housing, and may terminate in a drive mechanism for rotating the toothed metering elements. A second drum axle may extend through the wall and terminate in the drive mechanism for rotating a second set of toothed metering elements, and in some aspects, the drive mechanism may rotate the drums 302 in opposing rotational directions. Axles may be linked through the drive mechanism, such as a gearbox, a drive system by any suitable device or combination of devices. Linking devices may be, but are not limited to, belts, chains, gears, a computer controlling one or more electric, pneumatic or hydraulic motors, hydraulic oil linking one or more hydraulic motors, electrical current controlling one or more electric motors, pneumatics controlling one or more pneumatic motors, and the like. The linking devices or the drive mechanism may be rotated in a sufficiently controlled manner to enable the flow of fibers to a mix system. Optionally, the flow of fibers may be variably controlled.

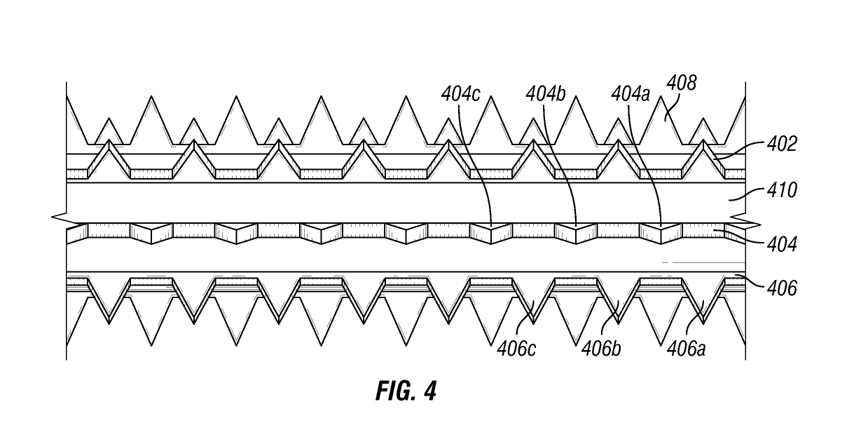

Now referring to FIG. 4, which illustrates a pattern of a plurality of toothed metering elements, in perspective view according to some aspects of the disclosure. Toothed metering elements 402, 404, 406 and 408 (each including several teeth positioned adjacent one another) are secured to drum 410. Teeth on each toothed metering element are position in such way that the teeth are offset from the next toothed metering element. For example, as depicted in FIG. 4, teeth 404a, 404b, 404c of toothed metering elements 404 are offset in position from teeth 406a, 406b, 406c of toothed metering elements 406. Such offsetting tooth orientation may allow a plurality drums to be positioned within a housing of a fiber feed control apparatus nearer one another, thus providing sufficient transformation of a fibrous mass into more discrete fibers. Further, such a tooth orientation, in some configurations, enables a plurality of drums and offset toothed metering elements to be positioned in such way where the drums are closely positioned in relation to one another and the offsetting teeth of one drum may pass through or near the interstitial space formed between teeth of another drum, while the drums are simultaneously rotated. Also, the offsetting tooth orientations may enable the teeth to more optimally work against the shear bar to meter fiber from the region of controlled bridging of the fibrous mass above the shear bar, to generate discrete fibers passing through and out of the discharge opening of the fiber feed control apparatus.

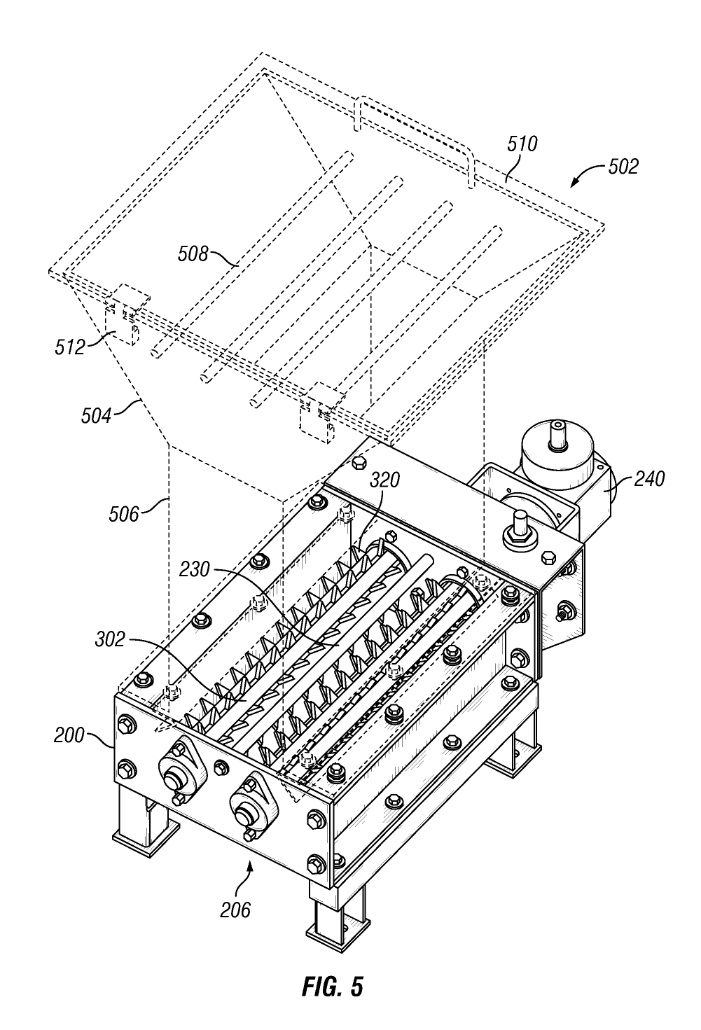

Referring now to FIG. 5, which depicts a vertical hopper 502 disposed adjacent a fiber feed control apparatus 200, in accordance with some aspects of the disclosure, and in a semi-transparent perspective view showing internal components. Vertical hopper 502 may include upper funnel section 504 and chute section 506. While the chute section 506 may have a generally rectangular cross section as shown in FIG. 5, the chute section 506 may have other configurations as well. The upper funnel section 504 may angle such that the funnel section may narrow or widen from top to bottom. Similarly, the vertical hopper 502 may be placed substantially perpendicular upon fiber feed control apparatus 200, or in some cases, rather may sit at an angle. Vertical hopper 502 may further include bars 508 (four shown) disposed in the upper funnel section 504 to help control addition of fibrous mass(es) into the hopper 502, as well as preventing large objects from entering hopper 502 and fiber feed control apparatus 200. A hinged lid 510 may be secured to upper funnel section 504 with hinges 512 (two shown) to allow access to the hopper, and allow isolation from the outer environment. A mass of fibers may be placed in and fill vertical hopper 502, as well as be in contact with upper inner components of fiber feed control apparatus 200, such as drums 302 (two shown), toothed metering elements 320, and shear bar 230. Within the intake fiber feed control apparatus 200, toothed metering elements 320 are rotated by a drive system attached to gearbox 240 and work in conjunction with shear bar 230, to break up the fibrous mass and meter the discharge of fibers from discharge opening 206.

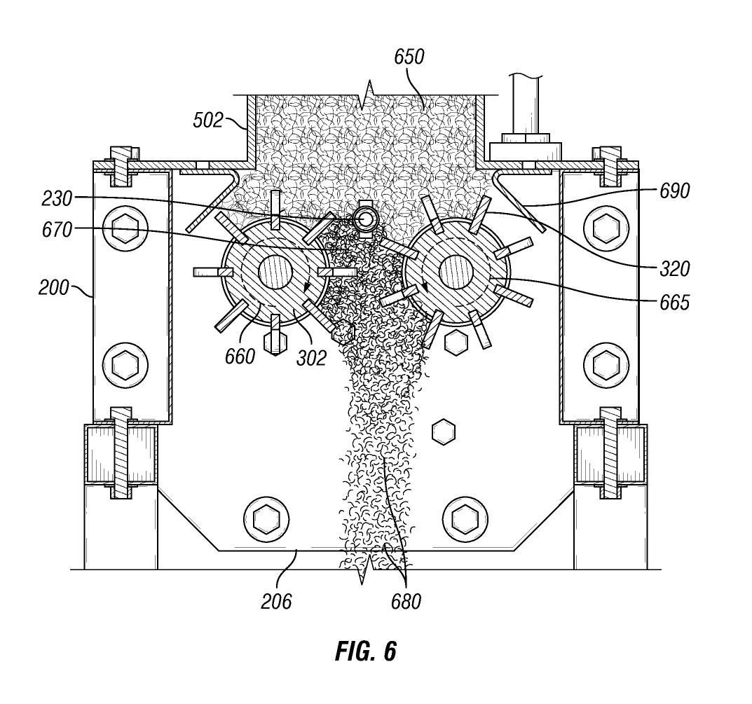

FIG. 6 illustrates operation of vertical hopper 502 and fiber feed control apparatus 200 in cross-sectional view. Fibrous mass 650 is shown resident in vertical hopper 502 and in contact with drums 302 (two shown), some of the toothed metering elements 320 (16 shown), and shear bar 230. A region of controlled fiber bridging with substantially uniform density may form adjacent drums 302 and some of the toothed metering elements 320. As the two drums 302 are rotated in counter directions 660, 665, a portion of fibrous mass 650 may be forcibly pulled by toothed metering elements 320 toward the center of fiber feed control apparatus 200, make contact with or pass near shear bar 230, and then resolve to more discrete fiber masses 670. Where a portion of the fibrous mass 650 in contact with toothed metering elements 320 is undesirably bound, the toothed metering elements 320 may provide adequate force to unbind, or otherwise rip, the bound portion of portion of the fibrous mass to produce discrete fiber masses 670. Discrete fiber masses 670 may then further pass between the rotating drums 302 and toothed metering elements 320, and in some instances, come into contact with drums 302 and elements 320, which may further promote separation of discrete fiber masses 670 into discrete small fibers 680. The fibers 680 may then travel through a lower portion of fiber feed control apparatus 200, discharge from discharge opening 206 at targeted rate, size, and into a mix system or fluid stream. To avoid fibers, or portions of fibrous mass 650, from bypassing the rotating action and forces generated by drums 302 and toothed metering elements 320, barriers 690 (two shown) may be placed within upper and outter portions of the interior of apparatus 200.

For a fracturing application such as that described above, the fiber 680 may be delivered to the mix system or fluid in fragments of between about 5 mesh and about 100 mesh. Additionally, the fiber 680 may be made up of a natural or synthetic glass, polymeric material, ceramic, metal, and the like. In some aspects of the disclosure, fiber 680 of the same or similar type and characteristics may be employed as part of a cement slurry mixture 513 as detailed further below.

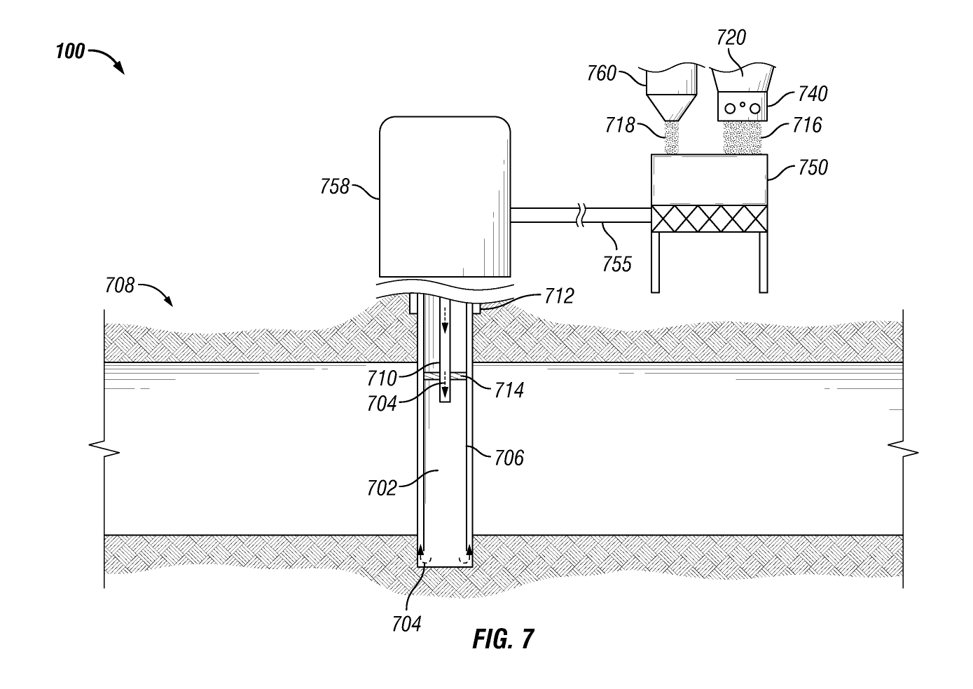

Continuing now with reference to FIG. 7, a cementing application employing fibers delivered by a fiber feed control apparatus is described. The cementing application may be carried out at the oilfield 100 depicted and as part of a completion operation targeting the production of hydrocarbons from a well 702. However, as compared to the embodiments of FIG. 1, focus is drawn to the delivery of a cement slurry mixture 704 to the well 702 as detailed below.

A cement slurry mixture 704 is delivered to the well 702 in order to secure a borehole casing 706 in place within the formation 708. Cementing in this manner may follow drilling of the well 702 itself where a drill bit is rotatably driven into the formation to drill the well 702 with the aid of drilling and circulating mud. Subsequent cementing may take place wherein a delivery pipe 710 is driven past uphole sections of in place borehole casing 712, through a cement plug 714 and to un-cemented downhole borehole casing 706. A cement slurry mixture 704 is then delivered downhole and forced between the casing 706 and the formation 708 for securing the casing 706 in place. Large scale cement pumps may be employed to deliver the cement slurry mixture 704 as shown. A cementing application such as that described above may take place in advance of, or in addition to, a fracturing application as also detailed herein. That is, depending on the design of the overall completion operation, fracturing and cementing techniques may both be employed for the purpose of furthering removal of hydrocarbons, again, generally oil and natural gas, from the formation 708.

Continuing with reference to FIG. 7, constituents 716 and 718 of the cement slurry mixture 704 are initially combined at a mix system 750, similar to the fracturing operation embodiments described in FIG. 1. Again, due to the nature of the combined mixture 704, the constituents 716 and 718 are combined at the oilfield 100 at the time of cementing. Thus, the mixture 704 may be advanced throughout the cementing equipment and through the well 702 prior to taking on properties that substantially impede its advancement therethrough. The mix system 750 is shown receiving fibers 716 from a fiber feed control apparatus 740 whereas other constituents 718 are delivered through a feeder 760. These other constituents may include a conventional fluid cement slurry 718. The slurry 718 may be premixed or components thereof individually provided to the mix system 750 for mixing thereat. Regardless, the fiber 716 is individually provided to the mix system 750, in some instances, upon addition of the cement slurry 718 or its components thereto. Fiber 716 is to be separately or individually added to the mix system 750 as indicated, a fiber feed control apparatus 740 may be provided to receive a fiber mass 720 and discharge the fiber 716 to mix system 750. Although specific embodiments of the fiber feed control apparatus 740 are described above, the fiber feed control apparatus 740 may be any apparatus appropriate for metering, separating and optionally cutting, fiber mass 720 as fibers 716 are delivered to the mixing system 750.

The cement slurry mixture 704 may be provided to the well 702 after preparation in a mixing system 750. Once the mixture 704 is attained it may be directed through the well 702 by one or more pumps. For example a series of conventional large scale triplex or quintuplex pumps (not shown) may be employed together, linked through a common manifold and coupled to the well head 758. An exit pipe 755 may be employed to carry the mixture 704 from the mix system 750 to the above noted pumps or other post-mix processing locations at the oilfield 100.

The fiber 716 may provide a web-like character to the cement slurry mixture 704. The web-like character may take hold in relatively short order. For example, the flow of mud and other contaminants may be substantially eliminated within a matter of hours, even prior to the complete setting and hardening of the mixture 704 between the casing 706 and the formation 708. This helps prevent undesirable flowback as noted above, safeguarding cementing equipment. However, as in the case of fracturing, the nature of the mixture 704 also calls for the addition of fiber 716 only on site at the time of the operation rather than by way of pre-blending into the slurry 718 off-site. Also, fiber 716 may be added to the mix system 750 at a suitable rate for cementing operations, such as between about 1 kgs and about 20 kgs per minute.

The above described embodiments allow for the controlled and metered addition of flowback inhibiting fibers to oilfield fluid mixtures without requiring a significant amount of manual labor. This is achieved by the employment of a fiber feed control apparatus, which, as detailed above, may be employed to drastically reduce the human cost incurred that results from the necessity of on-site fluid mixture blending. Additionally, the use of a fiber feed control apparatus provides a degree of precision in the metering or rate of fiber addition to the application fluid mixture heretofore unavailable.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may be present, for example.

Although the terms first, second, third, etc. may be used herein to describe various elements, components, regions, layers and/or sections, these elements, components, regions, layers and/or sections should not be limited by these terms. These terms may be used only to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. An apparatus for controlling feed of fibers into a fluid, the apparatus comprising:
a housing having an intake opening and a discharge opening;
a plurality of toothed metering elements mounted on a plurality of spindles, the spindles rotatably mounted within the housing;
a shear bar disposed above and between the plurality of toothed metering elements; and,
a fluid disposed adjacent the discharge opening for receiving fibers.

2. The apparatus of claim 1 wherein a mass of fibers is introduced into the apparatus via the intake opening, wherein the mass of fibers contacts the shear bar and the plurality of toothed metering elements, and wherein delivery of the fibers to the fluid is metered by controlling rotational speed of the plurality of toothed metering elements.

3. The apparatus of claim 2 wherein the plurality of spindles is two spindles, and wherein the two spindles rotate in opposite directions.

4. The apparatus of claim 2 wherein the mass of fibers is divided into substantially discrete fibers by the contact with the shear bar and the plurality of toothed metering elements.

5. The apparatus of claim 4 wherein the discrete fibers are deliverable to the liquid.

6. The apparatus of claim 1 wherein the spindles are drums, the drums each comprising a plurality of slots disposed on the surface of the drum parallel with an axial centerline of the drum, and wherein the slots accommodate inserts comprising the toothed metering elements.

7. The apparatus of claim 6, wherein each of the drums comprise distal axles disposed upon the axial centerline of the drum and extending from each end of the drum, a retainer cap disposed over each axle and mated with the drum to secure the inserts, and a lock for securing the retainer cap over the axle.

8. The apparatus of claim 1 wherein the shear bar acts as a shearing surface for the toothed metering elements to force a mass of fibers against.

9. The apparatus of claim 1 wherein the shear bar prevents fiber loaded into a hopper disposed above the drums from binding between the spindles.

10. The apparatus of claim 1 wherein the toothed metering elements unbind and shear the mass of fiber against the shear bar to separate the fiber and meter fiber through the discharge opening.

11. The apparatus of claim 1 wherein each of the plurality of toothed metering elements comprises a variable tooth geometry.

12. The apparatus of claim 1 wherein the plurality of toothed metering elements have staggered teeth patterning and the plurality of spindles are rotatable with clocking for greater averaging in metering performance.

13. The apparatus of claim 1 further comprising a hopper disposed adjacent the intake opening.

14. The apparatus of claim 1 wherein the fluid is a fracturing fluid.

15. The apparatus of claim 1 wherein the fluid is a cementing fluid.

16. A system comprising:
a fiber feed control apparatus comprising:
a housing having an intake opening and a discharge opening;
a mass of fibers received at the intake opening;
a plurality of toothed metering elements mounted on a plurality of spindles, the spindles rotatably mounted within the housing;
a shear bar disposed above and between the plurality of toothed metering elements; and,
fibers to be discharged at the discharge opening; and,
a fluid disposed adjacent the discharge opening comprising the fibers discharged by the fiber feed control apparatus.

17. The system of claim 16 wherein the mass of fibers contacts the shear bar and the plurality of toothed metering elements, and wherein delivery of the fibers to the fluid is metered by controlling rotational speed of the plurality of toothed metering elements.

18. The system of claim 17 wherein the plurality of spindles is two spindles, and wherein the two spindles rotate in opposite directions.

19. The system of claim 18 wherein the mass of fibers is divided into substantially discrete fibers by the contact with the shear bar and the plurality of toothed metering elements.

20. The system of claim 16 wherein the spindles are drums, the drums each comprising a plurality of slots disposed on the surface of the drum parallel with an axial centerline of the drum, and wherein the slots accommodate inserts comprising the toothed metering elements.

21. The system of claim 20, wherein each of the drums comprise distal axles disposed upon the axial centerline of the drum and extending from each end of the drum, a retainer cap disposed over each axle and mated with the drum to secure the inserts, and a lock for securing the retainer cap over the axle.

22. The system of claim 16 wherein the toothed metering elements unbind and shear the mass of fiber against the shear bar to separate the fiber and meter fiber through the discharge opening.

23. The system of claim 16 further comprising a hopper disposed adjacent the intake opening.

24. The system of claim 16 wherein the fluid is a fracturing fluid.

25. The system of claim 1 wherein the fluid is a cementing fluid.

26. A system for preparing a subterranean formation treatment fluid, the system comprising:
an apparatus comprising:
a housing having an intake opening and a discharge opening;
a mass of fibers received at the intake opening;
a plurality of toothed metering elements mounted on a plurality of drums;
a shear bar disposed above and between the plurality of toothed metering elements; and,
a mass of fibers for introduction into the intake opening;
a treatment fluid disposed adjacent the discharge opening; and, fibers to be discharged from the discharge opening;
wherein the fibers are continuously discharged at a substantially constant rate and added to the treatment fluid.
